(19) United States
(12) Patent Application Publication
(10) Pub. No.: US 2011/0196642 A1
(43) Pub. Date: Aug. 11, 2011

(54) SUBGRAPH SEARCHING

(76) Inventor: Jesse Newcomb, (US)

(21) Appl. No.: 12/870,753

(22) Filed: Aug. 27, 2010

Related U.S. Application Data
(60) Provisional application No. 61/303,507, filed on Feb. 11, 2010.

(51) Int. Cl. G06F 15/00

(52) U.S. Cl. 702/127

(57) ABSTRACT

Systems and methods for receiving a graphical pattern, wherein the graphical pattern comprises a collection of one or more electronic devices, using the graphical pattern searching for matches within the circuit, and reporting the matches.

### RELATED APPLICATIONS

This application is related to and claims priority to commonly assigned copending Provisional U.S. Patent Application No. 61/303,507, titled “CIRCUIT ANALYSIS,” by Jesse Newcomb, Docket No. Insight-1001-prov, filed Feb. 11, 2010, which is incorporated by reference herein in its entirety.

### FIELD

Embodiments of the present invention relate in general to the field of circuits.

### BACKGROUND

One approach to troubleshooting circuits is to involve specialized circuit hardware engineers and computer software programmers. These people coordinate their efforts to arrive at a solution that requires both circuit and programming expertise. Most circuit engineers do not have the programming skills necessary for complex evaluation of large circuit netlists, such as a full chip. Most software programmers do not have the circuit hardware knowledge necessary to troubleshoot a circuit. The process of troubleshooting a circuit design usually requires more skills than a single person can provide. What is needed is a way to refine the approach by curtailing software programmer involvement.

### SUMMARY

Systems and methods implementing subgraph searching are discussed herein. The method comprises receiving a graphical pattern, wherein the graphical pattern comprises a collection of one or more electronic devices, using the graphical pattern searching for matches within the circuit, and reporting the matches.

### BRIEF DESCRIPTION OF THE DRAWINGS

FIG. 1 illustrates subgraph search parameters using a graphical pattern, in accordance with embodiments.

FIG. 2 illustrates subgraphs for subgraph searching of FIG. 1, in accordance with embodiments.

FIG. 3 illustrates subgraph search parameters using a graphical pattern and a text pattern, in accordance with embodiments.

FIG. 4 illustrates subgraphs for subgraph searching of FIG. 3, in accordance with embodiments.

FIG. 5 illustrates a flow diagram for subgraph searching, in accordance with embodiments.

FIG. 6 illustrates a flow chart for subgraph searching, in accordance with embodiments.

FIG. 7 illustrates a block diagram of a computer for subgraph searching, in accordance with embodiments.

### DESCRIPTION OF EMBODIMENTS

In the following description, numerous specific details are set forth in order to provide a thorough understanding. However, it will be recognized by one of ordinary skill in the art that embodiments may be practiced without these specific details. In other instances, well known methods, procedures, and components have not been described in detail as not to unnecessarily obscure aspects of the present invention.

In one embodiment, a user is presented with a template, such as a subgraph template, used to select graphical images and/or type text content used for defining and/or building a subgraph search. A subgraph is an appearance of very specific patterns and/or physical attributes that may be found within a greater circuit. A subgraph template gives a user great flexibility to search and/or locate with great specificity particular electronic devices (“devices”), configurations, and/or combinations of devices and configurations. The subgraph template may alleviate the need to write programs every time a user desires to find a particular device/configuration. In one embodiment, the subgraph template is used to build a graphical pattern which represent the search criteria for the subgraph. In another embodiment, the subgraph template is used to build a graphical pattern and a text pattern which represent the search criteria for the subgraph.

The graphical pattern is some or all of the search criteria for the subgraph, wherein the graphical pattern is compiled by a user via a graphical representation of electronic devices, nodes, and associations between the devices and/or nodes. The text pattern is some of or all the search criteria for the subgraph, wherein the text pattern is compiled by a user via block of text. The search criteria may include information from the graphical pattern and/or the text pattern. Graphical and text patterns are discussed further and herein.

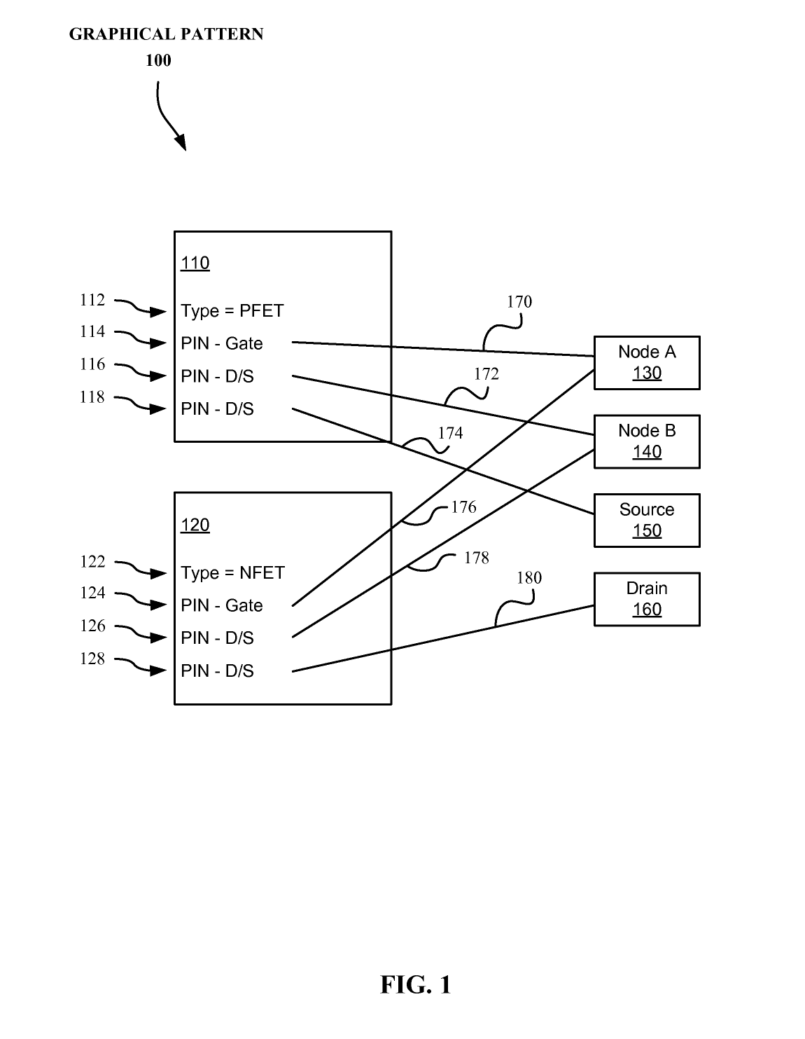

FIG. 1 illustrates subgraph search parameters using a graphical pattern 100, in accordance with embodiments. As depicted in one embodiment, the graphical pattern 100 comprises device characteristics 110, device characteristics 120, nodes, such as Node A 130, Node B 140, Power 150, and Drain 160, and associations 170-180. Device characteristics are characteristics of an electronic device, also referred to as device, and may include a device type, such as characteristic 112 set to “Type=PFET”, a pin attribute, such as pin attribute 114 set to “Pin-Gate” with an association, device geometries, device names, and the like. A device geometry is a physical dimension of a device, such as a width, a thickness and the like. A device name may be arbitrary nomenclature, such as “CoolTown”, and/or provide for a device identification, such as “NFET60” may identify the 60^{th} NFET.

A PFET and a NFET are types of a metal-oxide-semiconductor field-effect transistor (MOSFET), a device used for amplifying or switching electronic signals. A channel of the MOSFET can be of n-type or p-type, and is accordingly called an nMOSFET (NFET) or a pMOSFET (PFET), respectively.

Nodes are any electrical couplings of two or more devices, power sources and/or grounds. Nodes may be identified arbitrarily, such as Node A 130, or descriptively, such as Power 150 representing a power source.

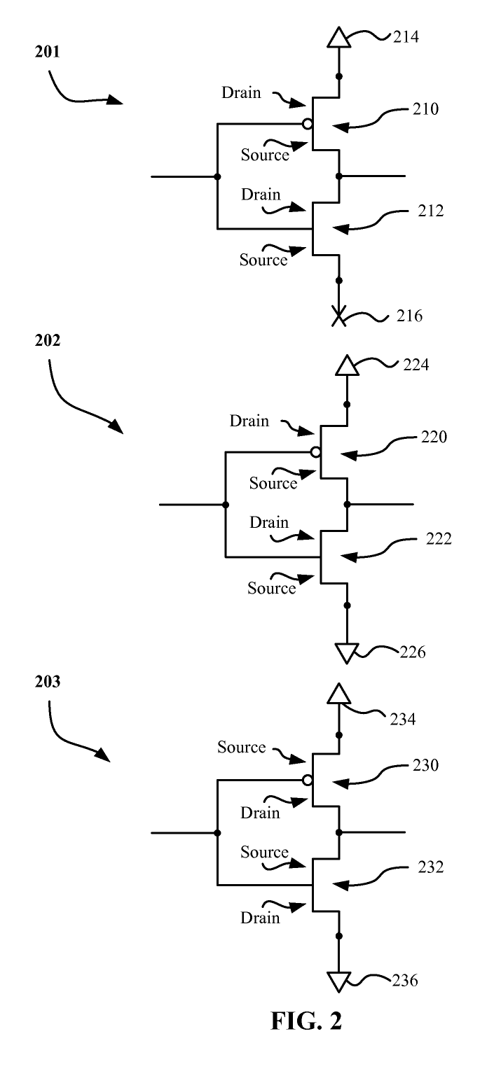

The graphical pattern 100 may couple a device characteristic with a node via an association, such as character 114 is coupled to Node A 130 via association 170. The associations 170-180 are discussed with regard to FIG. 2 and further herein.

As defined herein, a circuit element is a device or a node. Parameters are characteristics of the circuit element, for example a transistor has potentially hundreds of characteristics, some of which are related to pins, types, widths, and the like.

A user may define the characteristics and attributes for devices, nodes, and associations between the devices and/or nodes. Also, the user may specify the transistor to be a PFET, an NFET, or any kind of transistor. Additionally, the user may associate a node to be electrically coupled to two or more devices. For example a user couples two devices to each other, such as a device having device characteristics 110 and a device having device characteristics 120 are coupled together via Node B 140 using associations 170 and 178.

Also, the user may specify one or more pins of a device to be coupled to other nodes, sources, drains and/or other pins of other devices. In one embodiment, a user may specify any combination of characteristics, associations, and nodes that may be represented within a circuit.

In one embodiment, a subgraph template allows the user to construct and/or configure a device and/or device configuration. In one embodiment, the subgraph template allows a user to define search parameters of a circuit using a user interface. The user interface may contain blocks, connectors, and/or anything else to define and construct circuit components.

In one embodiment, a user may enter terms to perform a fuzzy search. Fuzzy searching is a process that locates subgraphs that are likely to be relevant to a search argument even when the argument does not exactly correspond to the desired information. A fuzzy search is done by means of a fuzzy matching program, which returns a list of results based on likely relevance even though search argument words and spellings may not exactly match. Exact and highly relevant matches may appear near the top of the list. Subjective relevance ratings, usually as percentages, may be given.

In one embodiment, wildcards may be used to offer a range of text values. For example, the name “co*d” may find cold and cord. In one embodiment, a graphical pattern and/or a text pattern is loosely defined. A loosely defined pattern may comprise one or more wildcards and/or a ranged attribute, such as greater than equation. Using searches with wildcards and loose definitions allows a user to select a wide range of parameters prior to knowing what the user may be searching, does not lock a user into a precise search, allows for broad searching, and/or permits several parameter with a few restrictions and/or rules.

In one embodiment, a user may choose a flipping of source and drain configuration. For example, the user selects from a pull down window the option of “D/S” and ties this pin to the node, such as Node B 140. The user also selects another pin's option as “D/S” and ties it to power, such as power 150. Additionally, for a second device, such as device characteristics 120, the user selects “D/S” options for two pins and ties these to Node B 140 and a drain, such as drain 160. Thus a user may effectively complete a flow from a source to a drain by coupling devices to each other and coupling one of the devices to the power and the other device to the ground, as shown in FIG. 1.

In one embodiment, a subgraph template provides a way for a user to describe certain object patterns within the circuit. Object patterns may be non-specific definitions and/or aspects that result in specific matches. An example of a non-specific aspect is an ability to apply wildcards to names, values, logical operators (such as greater than and/or less than). The non-specific aspects of combinations may be for multiple combinations of devices and/or nodes. The non-specific aspects may be an absence of any of the above or discussed herein. It will be recognized by one of ordinary skill in the art that other options may be selected for pins of devices that are characteristic of devices, such as the absence of a MOSFET 4th terminal, or the presence of a MOSFET deep N well terminal, or such as a “don't-care” condition.

In one embodiment, a subgraph template may comprise wildcards, combinations, and an absence of a circuit object and/or a device object. In one embodiment, an absence of a circuit object and/or or a device objection is interpreted as TRUE if the searching does not find the object and/or the device objection.

Various alternatives, modifications and equivalents may be used to build a graphical pattern from a subgraph template. In one embodiment, devices are conditionally coupled to nodes. For example, if a transistor has a width greater than 0.35 micrometers it is coupled to a ground with a voltage of +0.0 millivolts or if the transistor has a width of less than 0.20 micrometers it is coupled to a ground with a voltage of +0.2 millivolts. It will be recognized by one of ordinary skill in the art that embodiments may be practiced without such specific details.

FIG. 2 illustrates subgraphs 201-203 for subgraph searching of FIG. 1, in accordance with embodiments. The subgraph 201 comprises a PFET 210 and an NFET 212 coupled to each other at gates, and coupled to each other at a source side of the PFET 210 and the drain side of NFET 212. The drain side of the PFET 210 is coupled to a power 214. The source side of NFET 212 is coupled to a node 216. Node 216 is not directly coupled to either a source or a drain.

The subgraph 202 comprises a PFET 220 and an NFET 222 coupled to each other at gates, and coupled to each other at a source side of the PFET 220 and the drain side of NFET 222. The drain side of the PFET 220 is coupled to a power 224. The source side of NFET 222 is coupled to a drain 226.

The subgraph 203 is a source-drain flip of subgraph 202. The subgraph 203 comprises a PFET 230 and an NFET 232 coupled to each other at gates, and coupled to each other at a drain side of the PFET 230 and the source side of NFET 232. The source side of the PFET 230 is coupled to a power 234. The drain side of NFET 232 is coupled to a drain 236.

As shown, the subgraphs 202 and 203 satisfy the search specification of FIG. 1. Thereby, a search using the search specification of FIG. 1 would result in a notification of these findings. Thus, a user may effectively allow for a flipping of a power and a source via user selections similar to those of FIG. 1, such selections as the “D/S” for characteristics 116, 118, 126 and 128. Selecting a flipping allows a user to specific multiple configuration conditions for one search, thus saving time, resources and unique combinations of devices.

As shown, the subgraph 201 would not satisfy the search specification of FIG. 1, as the source side of the NFET 216 is not coupled to either a source or a drain. Thereby, a search using the search specification of FIG. 1 would not include the subgraph 201 in the findings.

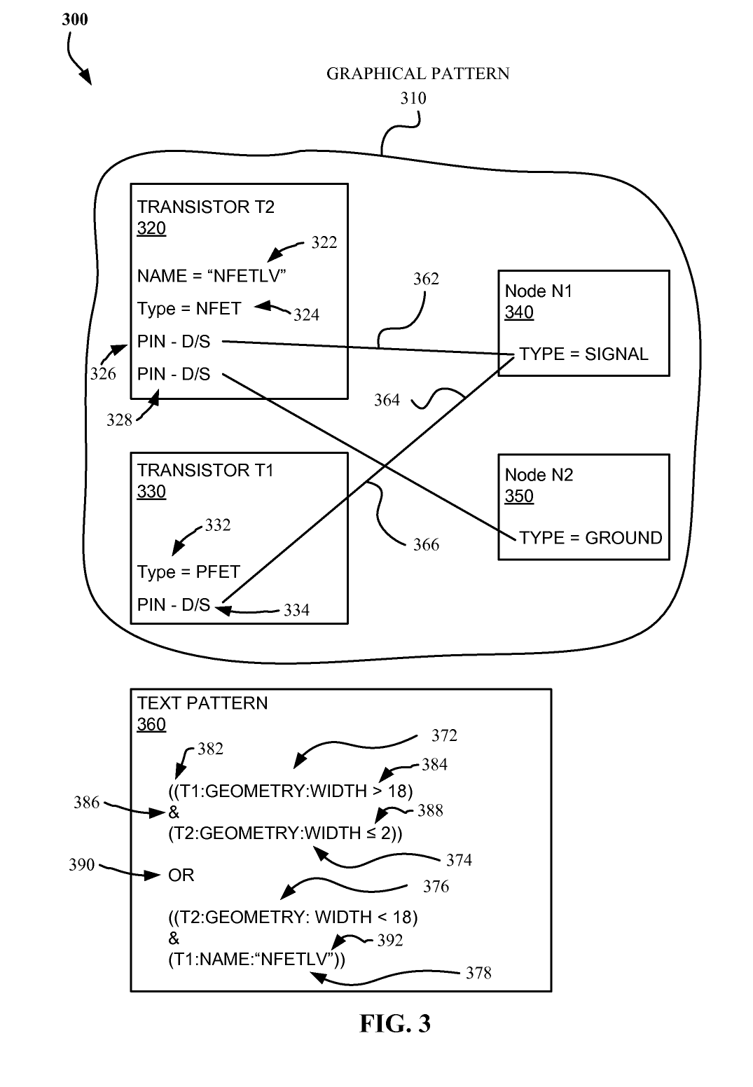

FIG. 3 illustrates subgraph search parameters 300 using a graphical pattern 310 and a text pattern 370, in accordance with embodiments. As depicted in one embodiment, the graphical pattern 310 comprises device characteristics, such as device characteristics for Transistor T1 320 and Transistor T2 330, nodes, such as Node N1 340 and Node N2 350, and associations 362-36. Device characteristics may include a device name, such as characteristic 322 is set to “NAME=‘NFETLV’”, a device type, such as characteristic 324 set to “Type=NFET”, a pin attribute, such as pin attribute 326 set to “Pin-D/S” with an association, device geometries, device names and the like.

As depicted in one embodiment, the text pattern 370 comprises text strings, such as text strings 372-378, and mathematical symbols, such as symbols 382-392. The text strings and mathematical symbols define device attributes and/or device characteristics. For example, “T1:GEOMETERY:WIDTH” 372 defines a geometric width for transistor 1, whereby “>18” specifies that the width is to be greater than 18 (micrometers).

In other embodiments the text pattern comprises one or more text strings and one or more mathematical symbol. In one embodiment, the text strings and the mathematical symbols define device attributes and characteristics that are not easily expressed using a graphical pattern. For example, search for A, where A is true if (X AND Y) OR (Y AND Z) OR (X AND NOT Z). It will be recognized by one of ordinary skill in the art that other options and/or combinations of mathematical expressions may be used to create text patterns.

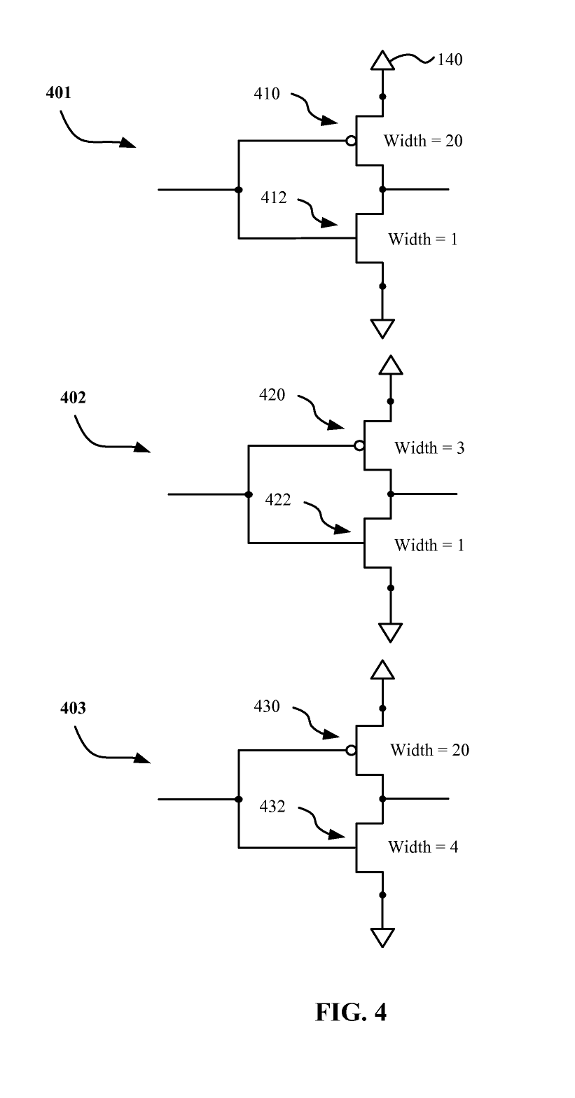

FIG. 4 illustrates subgraphs 401-403 for subgraph searching of FIG. 3, in accordance with embodiments. The subgraph 401 comprises a PFET 410 and an NFET 412 coupled to each other at gates, and coupled to each other at a drain side of the PFET 410 and a source side of NFET 412. The source side of the PFET 410 is coupled to a power. The drain side of NFET 412 is coupled to a drain. The PFET 410 has a width equal to 20 micrometers. The NFET 412 has a width equal to 1 micrometer.

The subgraph 402 comprises a PFET 420 and an NFET 422 coupled to each other at gates, and coupled to each other at a drain side of the PFET 420 and a source side of NFET 422. The source side of the PFET 420 is coupled to a power. The drain side of NFET 422 is coupled to a drain. The PFET 420 has a width equal to 3 micrometers. The NFET 422 has a width equal to 1 micrometer.

The subgraph 403 comprises a PFET 430 and an NFET 432 coupled to each other at gates, and coupled to each other at a drain side of the PFET 430 and a source side of NFET 432. The source side of the PFET 430 is coupled to a power. The drain side of NFET 432 is coupled to a drain. The PFET 430 has a width equal to 20 micrometers. The NFET 432 has a width equal to 4 micrometers.

As shown, the subgraphs 401, 402 and 403 meet the search criteria of the graphical pattern 310 portion of the subgraph search parameters 300 of FIG. 3. However, only subgraphs 401 and 402 satisfy the text pattern 370 of FIG. 3, as subgraph 303 does not satisfy the condition of T1 having a width equal to or under 2, as per text string 374, and does not satisfy the condition of T2 having a wide less than 18, as per text string 376.

In one embodiment, as subgraphs 301 and 302 satisfy the search parameters 300, results to this effect would be provided to a user. Searching and reporting mechanisms are further provided herein.

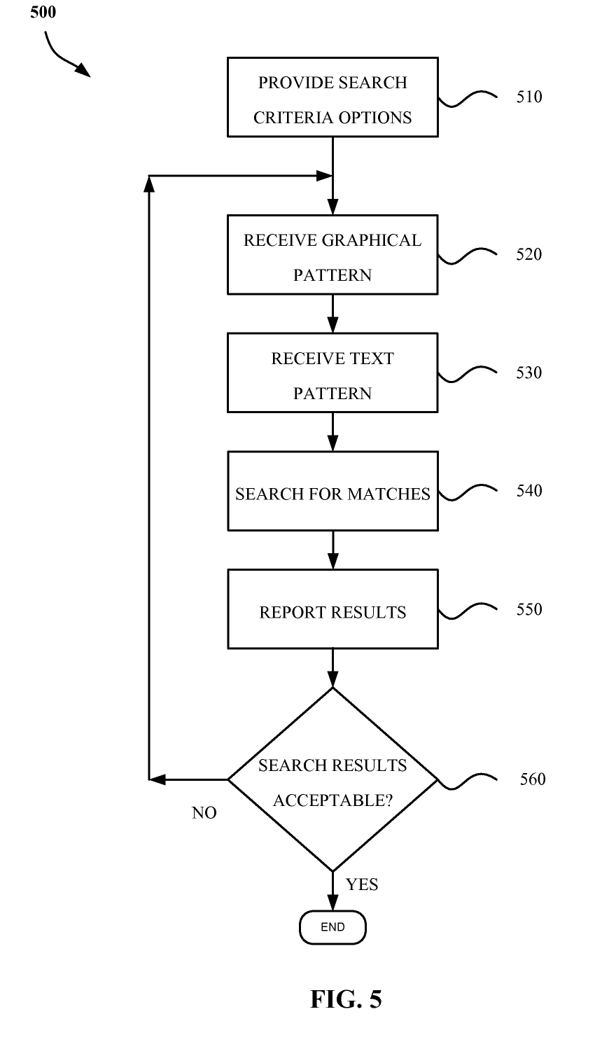

FIG. 5 illustrates a flow diagram 500 for subgraph searching, in accordance with embodiments. The flow diagram 500 optionally starts with step 510 by providing search criteria options to a user. The search criteria options provide a way for a user to select and/or indicate desired search criteria. The search criteria may include a graphical pattern, a text pattern, and the like. The search criteria options may be presented to a user in standard formats using templates, forms, boxes and the like. The user may select and/or enter search criteria options using a mouse, keyboard, touch screen and/or any other user input interface.

In step 520, a software application receives a graphical pattern from the user. In optional step 530, the software application receives a text pattern from the user.

In one embodiment, after the application receives the search criteria and a netlist, the application, in step 540 uses the search criteria to find matches, that is, subgraphs, in the circuit. In another embodiment, the application searches for subgraphs after receiving the graphical pattern and the netlist, performs a search, and then performs a subsearch, separate from the initial search, using the text pattern. Typically, the subsearch is a refined search of a first search using only the graphical pattern.

In one embodiment, the subsearch establishes a sub-group of potential discrepancies. Multiple sub-groups may be reviewed by a user to determine an appropriate troubleshooting scenario. For example, if there is a power leak, subgroups may be identified as sets to be analyzed rather than individual devices, thus saving time.

In one embodiment, two searches are performed, a target search and a trigger search. For the target search, the application performs a search for subgraphs using the graphical pattern. The subgraphs identified in the target search may be reduced in the trigger search, wherein a search (or subsearch) is performed using the text pattern.

Both the target search and the trigger search may be one or more complex conditions used for searching for subgraphs. In one embodiment, a complex condition is a relationship between parameters of two or more circuit elements. In one embodiment, a complex condition is a relationship between two or more circuit elements.

In one embodiment, the text pattern allows a user to help create higher order definitions. In one embodiment, the definitions are commonly constructed as Boolean relationships, which may not be well captured using only the graphical pattern. For example, the text pattern may set forth a relationship between various combinations of elements and attributes, such as depicted in FIG. 3.

In step 550, the application reports the results of the matches to the user. The report may list subgraphs, a frequency of similar subgraph types, and the like. In one embodiment, the report categorizes the subgraphs into groups based on similar troubleshooting resolutions, difficulty and/or complexity of troubleshooting, physical location within the circuit and/or the like.

In one embodiment, the user reviews the results to determine if the search results are acceptable. A user may determine if the results are acceptable based on the number of matched subgraphs, a preconceived subgraph the user is looking for and/or a comparison of the results to known issues, such as common failures and the like. For example, if the matched subgraphs are a common error known to the user, the user may determine the matches are desired, later to be used for trouble-shooting a circuit.

In one embodiment, the application determines if the search results are acceptable. The application may determine if the search/matched results are accepted based on the total number of results. For example, if the matched results are several thousand subgraphs, then the application may report a result that is too numerous to represent in a user friendly format if all the subgraphs are reported individually.

In step 560, if the search results are not acceptable, then the application returns to step 520, and requests a change and/or refinement of the graphical pattern and/or text pattern. This allows a user to refine search criteria. If the search results are acceptable, the application ends.

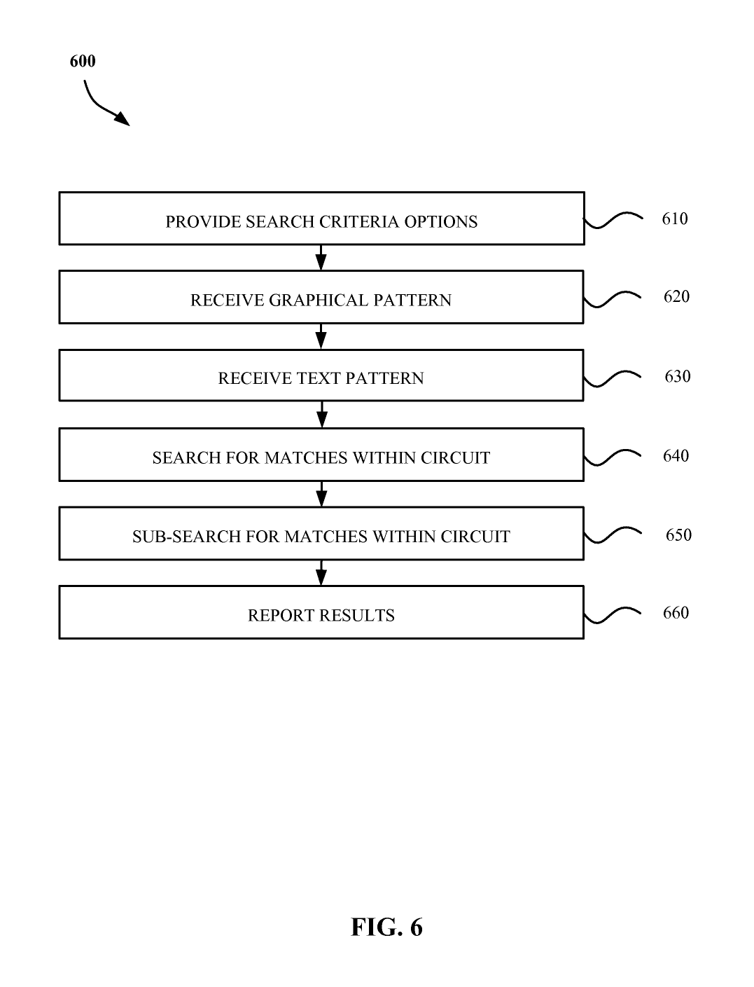

FIG. 6 illustrates a flow chart 600 for subgraph searching, in accordance with embodiments. In step 610, an application provides search criteria options to a user, as discussed herein. In step 620, a software application receives a graphical pattern from the user. In optional step 630, the software application receives a text pattern from the user.

In step 640, the application uses a graphical pattern of the search criteria to find matches, that is, subgraphs, within the circuit. In step 650, the application uses a text pattern of the search criteria to find matches within the circuit. In step 660, the application reports the results to the user.

In one embodiment, a search pattern uses the graphical pattern for more generic attributes and the text pattern for the more complicated attributes, as discussed herein. In another embodiment, a search pattern may be too complicated for use of the graphical pattern alone; that is, too complicated may be viewed as being too problematic to allow for the hundreds/thousands of combination/permutations to graphically represent a type of desired search pattern.

Various alternatives, modifications, and equivalents may also be used. For example, the steps of searching for subgraphs may combine one or more text patterns and/or one or more graphical pattern searches, in any order. In another example, subgraph searching may be conditionally branched depending on a prior search, such as if X number of subgraphs are found, then perform search one, otherwise perform search two. Therefore, the above description should not be taken as limiting the scope of the invention which is defined by the appended claims.

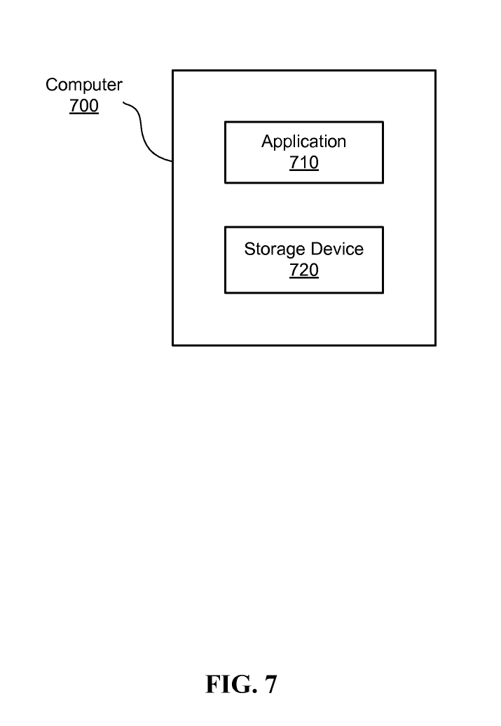

FIG. 7 illustrates a block diagram of a computer 700 for subgraph searching, in accordance with embodiments. As illustrated, the computer 700 comprises an application 710, and a storage device 720. The application 710 is configured to run on the computer 700, and configured to receive a netlist and search parameters (graphical patterns and text patterns), such as search parameters 300, from a user, and to use the search parameters to identify subgraphs, and to report results. The storage device 720 is configured to store information, such as search parameters (graphical patterns and text patterns), a netlist, search results and the like.

In various embodiments, the computer 700 contains a computer readable medium having embodied thereon a program, the program being executable by a computing device for performing a method for subgraph searching and reporting. The program is configured to receive search parameters; to receive a netlist and to report findings.

While the invention is described in conjunction with various embodiments, it is understood that they are not intended to limit the invention to these embodiments. On the contrary, the invention is intended to cover alternatives, modifications and equivalents, which may be included within the spirit and scope of the invention as defined by the appended claims.

What is claimed is:

1. A method for searching subgraphs in a circuit comprising:
receiving a graphical pattern, wherein the graphical pattern comprises a collection of one or more electronic devices;
using the graphical pattern, searching for matches within the circuit; and
reporting the matches.

2. The method of claim 1, wherein the graphical pattern is loosely defined.

3. The method of claim 2, wherein the loosely defined graphical pattern comprises one or more wildcards.

4. The method of claim 2, wherein the loosely defined graphical pattern comprises a ranged attribute.

5. The method of claim 1, wherein the graphical pattern comprises at least one device, at least one pin connection, and at least one attribute.

6. The method of claim 5, wherein the attribute is a device geometry.

7. The method of claim 5, wherein the attribute is a device name.

8. The method of claim 1, wherein the graphical pattern comprises at least two electronic devices.

9. The method of claim 8, wherein the at least two electronic devices are connected to a common node.

10. The method of claim 1, further comprising providing search criteria options, wherein the graphical pattern is based on one or more of the search criteria options.

11. The method of claim 1, further comprising receiving a text pattern; and
using the text pattern, sub-searching for matches within the results of the searching.

12. The method of claim 11, wherein the search establishes a sub-group of potential discrepancies.

13. The method of claim 11, wherein the sub-search uses at least one Boolean relationship search.

14. The method of claim 11, wherein the sub-searching comprises fuzzy searching.

15. The method of claim 1, wherein the searching comprises fuzzy searching.

16. A method for searching subgraphs in a circuit comprising:
receiving a graphical pattern, wherein the graphical pattern comprises a collection of one or more electronic devices;
receiving a text pattern;
using the graphical pattern and the text pattern, searching for matches within the circuit; and
reporting the matches.

17. The method of claim 16, further comprising, using the text pattern, sub-searching for matches within the circuit.

18. The method of claim 16, wherein the graphical pattern is loosely defined.

19. The method of claim 16, wherein the loosely defined graphical pattern comprises one or more wildcards.

20. A computer readable medium having embodied thereon a program, the program being executable by a computing device for performing a method for searching subgraphs in a circuit comprising:
receiving a graphical pattern, wherein the graphical pattern comprises a collection of one or more electronic devices;
using the graphical pattern, searching for matches within the circuit; and
reporting the matches.
